(19) United States
(12) Patent Application Publication
(10) Pub. No.: US 2006/0047650 A1
(43) Pub. Date: Mar. 2, 2006

(54) Trainable record searcher

(76) Inventors: Thomas M. Freeman, Piedmont, CA (US); Stephanie Mendelson, Alameda, CA (US)

Correspondence Address: Thomas J. McWilliams, Esq.;Reed Smith, LLP, Intellectual Property, P.O. Box 7990, Philadelphia, PA, 19101, US

(21) Appl. No.: 11/211,163

(22) Filed: Aug. 24, 2005

Related U.S. Application Data
(60) Provisional application No. 60/604,188, filed on Aug. 24, 2004.

(51) Int. Cl. G06F 17/30

(52) U.S. Cl. 707/5

(57) ABSTRACT

A trainable record searcher is described. The trainable record searcher includes an iterative rules engine including at least an existing knowledge set, a plurality of rules, developed and entered to the iterative rules engine by at least one expert in at least one field of interest, a plurality of records for review by the iterative rules engine, where the plurality of rules are iteratively applied by the iterative rules engine to at least one training record. Also, the iterative application of the plurality of rules results in at least one rule modification in accordance with the existing knowledge set, where the plurality of rules, including the at least one rule modification, are applied by the iterative rules engine to a batch selected from the plurality of records to assess a compliance level for the batch of the plurality of records.

### RELATED APPLICATIONS

This application claims priority of U.S. Patent Application Ser. No. 60/604,188, filed Aug. 24, 2004, the entire disclosure of which is incorporated by reference herein as if being set forth in its entirety.

### FIELD OF THE INVENTION

The present invention is directed to electronic record review and tracking, and, more particularly, to a trainable electronic record searcher and method for implementing electronic record retention and audit for compliance or other business or legal purposes.

### BACKGROUND OF THE INVENTION

Compliance with an ever-increasing myriad of regulatory controls is one of the biggest issues facing corporate America today. As a result of the excesses of the 1990s, the general public, the regulatory bodies and the legal community are taking compliance seriously. Corporations are being forced to hold their employees to defined standards, and management is being held responsible for the failure to do so. The Sarbanes Oxley Act, in particular, has heightened the intensity of the enforcement of these standards. Companies that fail to comply with regulatory controls face serious and expensive penalties. However, even with willing and dutiful corporate management, it is difficult to monitor the actions of thousands of employees. This is especially true, for example, for employee email traffic in a large corporate entity. Larger corporations produce millions to billions of pages of email each year. Employees use email for every conceivable purpose, including business related and non-business purposes.

Electronic records are increasingly targeted in lawsuits, government investigations and routine regulatory examinations. In a recent survey by the American Management Association 20% of companies surveyed reported that they had had employee emails subpoenaed as part of a lawsuit or regulatory investigation in the last year. Thirteen percent of the respondents reported that employee emails were responsible for triggering lawsuits. The consequences of unmanaged electronic records and unregulated email usage may cost a corporation a fortune in fines, penalties, increased insurance rates and falling stock prices. The failure to adhere to company record retention policies, such as by the improper destruction of records including emails during pending litigation, has already led to significant penalization of corporate entities in the United States.

Destroying every email immediately after it was sent, while viable, is neither practical nor possible. There are generally too many business-related records in email archives that must be retained for business and/or regulatory reasons to simply delete them all. In addition, in at least one market segment, regulators have indicated that the routine destruction of e-mails, without some intervening step of creating “required books and records” from such e-mails, would constitute a clear violation of applicable regulations.

To protect itself in today's highly litigious and regulated environment, a company needs an effective record management program in which its electronic records can be identified and classified for retention in conformance with applicable regulatory requirements, retrieved in the event of litigation or agency investigation, and disposed of when no longer necessary for business operations or the satisfaction of a regulatory or other legal requirement.

In addition, a company needs to know if its email contains correspondence that is either non-compliant with company policy or is illegal. But with employees averaging one email per hour (20,000 pages per year) it is impossible for a corporate compliance officer to be aware of even a fraction of the content.

Using a combination of statistics and applied computational linguistics, DolphinSearch®, Inc. has developed tools that can accurately, and cost effectively, perform content recognition on large volumes of electronic records.

To know that email sent by employees is in fact compliant with company policies and applicable laws, rules and regulations, a compliance officer must: a) review every email, or a projectable sample of all email; or b) install filters that prevent non-compliant email from being sent. Until recently, neither of these approaches was viable. Without question, blocking non-compliant emails would be an ideal solution. Unfortunately, it is not possible to build a filter that can actually spot the vast majority of non-compliant email. More particularly, except in the most obvious cases, artificial intelligence cannot yet determine if an email is in fact non-compliant.

Thus, a “review each correspondence” approach is presently untenable, even when coupled with statistical sampling, due in part to the unprecedented growth in the volume of email. To state with 98% confidence that a large email store is free of compliance violations might require that 400,000 randomly selected emails be reviewed. Experience shows that an auditor can review only about 800 emails per day, which places even quarterly compliance audits out of the realm of practicality.

Therefore, the need exists for a trainable record searcher, and a method of training a record searcher and searching, for accurately reviewing and tracking, such as for compliance purposes, large quantities of documents of one or more document types.

### SUMMARY OF THE INVENTION

The present invention describes a trainable record searcher. The trainable record searcher includes an iterative rules engine including at least an existing knowledge set, a plurality of rules, developed and entered to the iterative rules engine by at least one expert in at least one field of interest, a plurality of records for review by the iterative rules engine, where the plurality of rules are iteratively applied by the iterative rules engine to at least one training record. Also, the iterative application of the plurality of rules results in at least one rule modification in accordance with the existing knowledge set, where the plurality of rules, including the at least one rule modification, are applied by the iterative rules engine to a batch selected from the plurality of records to assess a compliance level for the batch of the plurality of records.

### BRIEF DESCRIPTION OF THE FIGURES

Understanding of the present invention will be facilitated by consideration of the following detailed description of the preferred embodiments of the present invention taken in conjunction with the accompanying drawings, in which like numerals refer to like parts:

FIG. 1 is a block diagram illustrating a trainable record searcher in accordance with the present invention; and

FIG. 2 is an exemplary embodiment of the present invention involving a flow diagram directed to record retention rules.

### DETAILED DESCRIPTION OF THE PREFERRED EMBODIMENTS

It is to be understood that the figures and descriptions of the present invention have been simplified to illustrate elements that are relevant for a clear understanding of the present invention, while eliminating, for the purpose of clarity, many other elements found in a typical searching and review system and method. Those of ordinary skill in the art may recognize that other elements and/or steps are desirable and/or required in implementing the present invention. However, because such elements and steps are well known in the art, and because they do not facilitate a better understanding of the present invention, a discussion of such elements and steps is not provided herein. The disclosure herein is directed to all such variations and modifications to such elements and methods known to those skilled in the art.

Understanding of the present invention will be facilitated by consideration of the following detailed description of the present invention taken in conjunction with the accompanying drawings.

The present invention includes a multi-industry solution for electronic record review and tracking, including email review, email and electronic record sorting, and tracking of the implementation of record retention policies, for example. More particularly, the present invention includes a trainable record searcher, wherein a search module of the trainable record searcher may be trained to find records, such as emails, reports, and the like, that are most responsive to particular queries. Such a searcher may be trained, for example, with unique regulatory and/or record retention requirements for a particular industry, and may thus be advantageously implemented to perform record review and tracking in that industry.

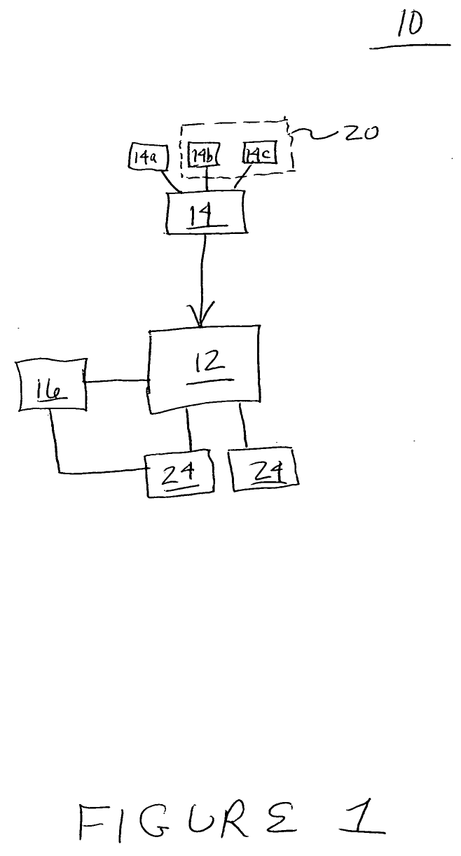

FIG. 1 is a block diagram illustrating a trainable record searcher in accordance with the present invention. The trainable record searcher 10 includes an iterative rules engine 12, wherein a plurality of rules 14 may be entered by methodologies apparent to those skilled in the art, such as by remote or local data entry, to the rules engine. The iterative rules engine, based upon a review of an initial set, subset, or sample of records employed as training records 16, may iteratively modify the plurality of rules 14, based upon the results of the review of the training records, in order to achieve the programmed goals of the entered rules with respect to the actual records to be reviewed. Additionally or alternatively, the plurality of rules may be modified manually by one or more operators in accordance with perceived results of the review of the training records by the rules engine using the initial plurality of rules.

For example, an initial application of the rules to training records may not result in the obtaining of a stated goal, such as wherein 10% of a set of training records are known to qualify as “client related emails.” In this example, only 7% of the training records may be classified by the searcher, according to application of the rules, as “client related emails.” In such a case, the rules engine may “know”, through previously learned knowledge gained through application of systems in accordance with the present invention, that inclusion of mis-spellings of a client's name within two characters generally results in a 3% increase in locatings of a client's name in email traffic. Therefore, the rules engine may modify the applied rule to gain the proper results with respect to the training records, and the modified rule may then be properly applied to the general record population.

The plurality of rules may include one or more rules 14a, 14b, 14c for record review, tracking, or classification relevant to regulatory or other requirements in an industry of interest. Each plurality of rules may be, for example, a subset of a rules superset 20, wherein the rules superset may include selectable access to a plurality of rules each relevant to one of multiple different industries, and wherein the rules superset may have selected therefrom the plurality of rules relevant to the particular industry of interest. Each rule 14a, 14b, 14c in each plurality of rules 14 may be designed, modified or implemented in accordance with input from experts, such as legal experts, familiar with the industry to which that plurality of rules is to be applied.

The iterative rules engine has accessible thereto one or more pluralities of record sets 24. The record sets may include, for example, multiple pluralities of records for review, wherein each record of each plurality is in electronic form, or is readily convertible to electronic form. The record sets may be or include, for example, files, reports, daily logs, emails, calendars, or the like, by company, department, person, or set of persons, for example.

The trainable searcher, as illustrated in FIG. 1, includes a searcher. The searcher may be a search engine as known to those skilled in the art. The search engine may search by a spider search, a randomized search, a relevancy matching search, which relevancy matching may start from a record subset and expand outward until wholly irrelevant subsets are reached, or any other search methodology known to those skilled in the art, in accordance with the applied rules. The search engine has accessible thereto the rules of at least one of the plurality of rules, and the at least one of the pluralities of record sets. In accordance with receipt of one or more rules, the searcher formulates a search query and searches the plurality of records for relevant ones of the records, wherein relevancy is assessed according to the rules.

The rules engine, including the searcher that applies the rules to the records, may be placed in communicative connection between a feed of the records and the rules entry. Rules may be entered by methodologies apparent to those skilled in the art, such as by manual entry from a computing terminal, or by receipt of one or more files containing the rules from a separate computing system. As such, the rules entry mechanism of the rules engine may include one or more rules normalization mechanisms, such as code converters or the like.

The records to which the rules are to be applied by the rules engine may be electronic and may be available from one or more servers. Alternatively, paper records may be transferred to electronic format, such as by optical character recognition (OCR) scanning, and the electronic conversions may be stored to the one or more servers. A server may be, for example, an electronic media, such as a network server or personal computer, capable of accessing electronic records from a storage media associated with the server, and capable of electronically implementing commands from the rules.

The communicative connection of the rules engine between the rules entry and the records to be reviewed may be a real time, continuous accessing of the records by the rules engine in accordance with the rules, or may be a batch accessing of the records at predetermined intervals. Because the rules engine operates on the records being passed therethrough, a slight delay in the passing of the records, such as emails, through a real time rules engine may occur. Therefore, a batch application of the rules to electronic records after those records have been passed may eliminate the need for such a delay in the passing of those records. Consequently, a batch application of the rules by the rules engine to the records may occur in parallel with the normal electronic processing of the business process under study. Further, because, in certain instances, the rules may dictate that the rules be applied to only a sampling of records generated, such as in cases where extraordinarily large numbers of records are generated by the business process under study, a batch application of the rules to the records may provide improved randomization to the sampling.

The trainable searcher may have particular relevance in industries wherein record searching, review, and tracking are highly necessary, such as due to intense industry regulation, and wherein such searching, review and tracking are particularly daunting due to volume and variety of electronic records, for example. Such industries may include, for example, the investment advising, brokering, and financial industry, the pharmaceutical, pharmaceutical testing, medical device, medical device manufacturing, and health care industries, and any industry in which record retention or monitoring policies are implemented and monitored. The trainable searcher may be most preferable applied in an instance wherein the industry of interest: (i) has regulations governing record retention; (ii) has regulations governing permissible and impermissible conduct; (iii) is subject to litigation, such as litigation that could be impacted by the contents of e-mail correspondence; and (iv) has lawyers and other experts that can offer to the trainable searcher expertise normally employed in manual record search and review.

The application of the present invention allows for the location of materials, such as those in e-mail, that are presumptively required records based on the applicable regulatory requirements that have been programmed into the system, but that have historically been difficult to locate due to the need to search printed copies, or electronic copies, of all emails manually. For example, the present invention may determine, with 98% confidence, materials that do not contain non-compliant conduct.

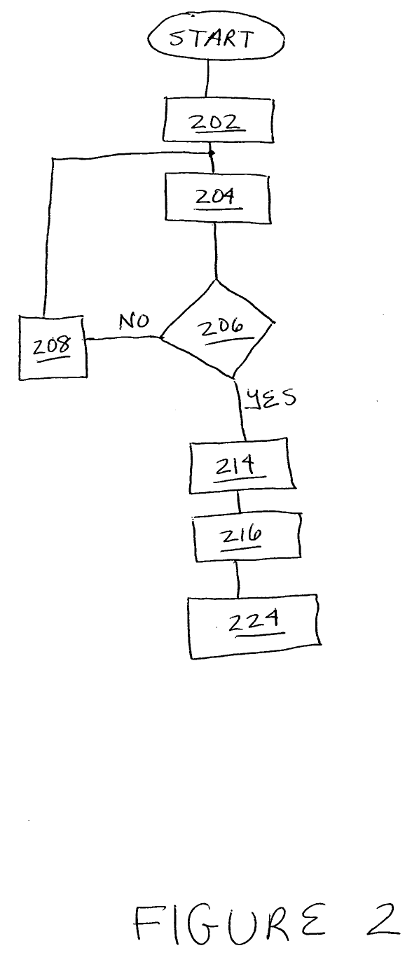

FIG. 2 is a flow diagram illustrating a non-limiting, exemplary embodiment of the invention discussed hereinabove with respect to FIG. 1. Although the exemplary embodiment discussed with respect to FIG. 2 is directed to a record retention rules example, it will be apparent to those skilled in the art that other rule types may be similarly implemented through the use of the present invention.

At step 202, a party having expertise in a relevant industry of interest may review, summarize, and create electronic compliance rules in accordance with rules promulgated under one or more laws or one or more corporate policies, such as rules regarding record creation and retention obligations of an entity. Such generation of electronic compliance rules may be via entry by an electronic operator to electronic means, such as by typing or dictating to a computing terminal, or via incorporation from an existing set of accepted electronic rules into a normalized format for use in the present invention. The generation of compliance rules may include goals or accepted guidelines for the application of the rules. For example, the purpose of the exemplary audit discussed hereinbelow may be to state with 98% confidence (+/−1%) that there are no compliance violations in a selected email population. In other words, if a complaince violation exists, then it will be located by the application of the rules by the rules engine 98% of the time. Further, a guideline may include that emails containing compliance violations occur at a rate of not less than one per 100,000 emails. Additionally, a guideline may include an initial estimate, for example, of a number of records to be searched from a total record population.

At step 204, the rules, including goals and guidelines, as entered may be accepted to the rules engine. The rules so entered may serve to both educate the searcher in the rules engine, and provide for application of the rules by the rules engine. The rules engine may, either before or after application of the rules received to a series of training records, modify the rules in order to achieve the goals, using pre-existing knowledge of the rules engine.

At step 206, the rules are applied against a set of training records, wherein the number of training records is preferably significantly smaller than the number of total records to be searched. The rules engine may have pre-existing knowledge that is applied in the application of the rules to the training records. For example, it may be known that attorneys attempting to use a word search to retrieve records about a given subject have a record locating rate of 20%. In other words, for each set of word search terms submitted, relevant records have a 1 in 5 chance of being retrieved by an attorney. However, the rules engine may include the pre-existing knowledge that increasing the number of unique word search sets used to find records about a topic increases the probability of retrieving records in the set related to that given topic. This increase in probability is additive such that, for example, using two distinct, word search sets increases the probability of a relevant record being retrieved to about 35%. Therefore, the rules engine may have the existing knowledge that a fuzzy logic search by the searcher of the rules engine, that is, a search in which the word search entered is expanded to include words and logic that are known to be associated with the entered search term, will increase the probability of retrieval of relevant records in the search. Consequently, the searcher of the rules engine may have a pre-existent understanding of logical word and phrase associations, and may apply those associations to the terms to be searched in association with the entered rules.

The application of the rules to the training records will result in meeting of the goals, or non-meeting of the goals, in application of the rules. If the goals are met, the rules may be applied to the “live records” to be searched. If the goals are not met, the rules may be modified 208, either manually or in accordance with pre-existent knowledge of the rules engine. After modification, the rules engine may again apply the rules to the training records, and may repeat the process until the stated goals are achieved with respect to the training records.

In this exemplary embodiment, the training record application may dictate that, to audit with a 98% confidence level, a sample of 400,000 email correspondences must be drawn from an entire record population at random. Thus, the searcher of the rules engine may select, at random, a set of 400,000 email correspondences from the total email stores at step 214. For each rule being audited, the searcher may then run a series of fuzzy logic searches against the 400,000 random sample, wherein the searches are constructed to find records related to the topic of the rule, at step 216.

In an embodiment, the application of the fuzzy logic searches may be staged, in order to improve search results. For example, at a first stage discussed hereinabove, a particular number of the 400,000 records may be obtained in accordance with the first stage search. For example, the particular records obtained in the first search may relate to the record retention policy of the company. Then, at stage two, another rule may be applied to the particular records resulting from the stage one search. This stage two application may be one or more fuzzy logic searches constructed to find compliance violations from the population of records known to be related to the record retention policy.

Results of a search may be normalized, ordered, automatically printed, or categorized according to yet another rule application, for example, at step 224. Preferably, the operation at step 224 may make the results more readily reviewable to an expert in the field of interest, such as by generating a report, summary, of the like, for a human reviewer.

Once the results of the one or more searches are made readily reviewable, a person having expertise in the area of interest may review, for example, just the first 6,000 results for proper location of compliance violations. If no improprieties in the search results are found, then the rules and goals may dictate that it can be stated with 98% confidence, +/−1%, that any compliance violations in the total email population have been properly located.

The location of compliance violations with regard to the rule set applied by the rules engine may lead to additional applications of the same, modified, or additional rule sets by the rules engine. Further, the hierarchical nature of the searching in the present invention may allow for particular focus in subsequent searches for further compliance violations in a small subset of the total record population in which a first one or more compliance violations have been found.

The present invention may be provided to corporations, universities, government agencies, or other entities that need to do compliance checks in certain topical areas. The present invention may be provided as a product, such as for an annual, one-time, or other license or royalty fee, directly to the subject entity, or may be provided as part of a service provided by one or more service providers having expertise in the particular area of interest for a given entity. Such a license or royalty fee may, for example, correspond per email user account to be monitored, and such a service provider charge may correspond to an hourly, bulk review, or other rate type.

The disclosure herein is directed to the variations and modifications of the elements and methods of the invention disclosed that will be apparent to those skilled in the art in light of the disclosure herein. Thus, it is intended that this description cover the modifications and variations of this invention, provided those modifications and variations come within the scope of the appended claims and the equivalents thereof.

We claim:

1. A trainable record searcher, comprising:
an iterative rules engine including at least an existing knowledge set;
a plurality of rules, developed and entered to said iterative rules engine by at least one expert in at least one field of interest;
a plurality of records for review by said iterative rules engine;
wherein said plurality of rules are iteratively applied by said iterative rules engine to at least one training record, and wherein the iterative application of said plurality of rules results in at least one rule modification in accordance with the existing knowledge set; and
wherein said plurality of rules, including the at least one rule modification, are applied by said iterative rules engine to a batch selected from said plurality of records to assess a compliance level for the batch of said plurality of records.

2. The trainable record searcher of claim 1, further comprising a search engine for searching said plurality of records.

3. The trainable record searcher of claim 2, wherein said search engine implements at least one of said plurality of rules in a search of said plurality of records.

4. The trainable record searcher of claim 3, wherein a relevancy of said search is determined by said plurality of rules.

5. The trainable record searcher of claim 1, wherein said plurality of records are electronic.

6. The trainable record searcher of claim 1, wherein said plurality of rules are entered manually.

7. The trainable record searcher of claim 1, wherein said plurality of rules is selected from a rules superset, wherein said rules superset may include selectable access to rules relevant to said at least one field of interest.

8. The trainable record searcher of claim 1, wherein said plurality of rules comprises at least one rule for each of record review, record tracking, and record classification to regulatory requirements specific to said at least one field of interest.

9. A method of searching records, comprising:
generating at least one electronic compliance rule;
entering said at least one electronic compliance rule to a rules engine including at least an existing knowledge set;
applying said at least one electronic compliance rule to at least one training record, wherein said application satisfies at least one predetermined goal based on said existing knowledge set;
modifying any of said at least one electronic compliance rules that do not satisfy said at least one predetermined goal; and
implementing a search of a plurality of records according to said at least one electronic compliance rule and any of said modified rules for obtaining search results.

10. The method of claim 9, wherein said at least one compliance rule is related to a specific field of interest.

11. The method of claim 10, wherein said at least one compliance rule related to a specific field of interest is in accordance with at least one business policy.

12. The method of claim 9, further comprising generating guidelines for the application of said at least one electronic compliance rule.

13. The method of claim 9, wherein said implementing of said search is done on subsequent subsets of said plurality of records.

14. The method of claim 9, wherein said implementing of said search is done on said search results.

15. The method of claim 9, wherein said search results are modified according to a generated rule.
